(19) United States
(12) Patent Application Publication
(10) Pub. No.: US 2023/0420667 A1
(43) Pub. Date: Dec. 28, 2023

(54) NEGATIVE-ELECTRODE MATERIAL AND BATTERY USING THE SAME

(71) Applicant: Panasonic Intellectual Property Management Co., Ltd., Osaka (JP)

(72) Inventors: SHOHEI KUSUMOTO, Osaka (JP); MASAYOSHI UEMATSU, Osaka (JP); TOMOKATSU WADA, Osaka (JP); AKIHIKO SAGARA, Nara (JP)

(21) Appl. No.: 18/466,045

(22) Filed: Sep. 13, 2023

Related U.S. Application Data
(63) Continuation of application No. PCT/JP2021/044434, filed on Dec. 3, 2021.

(30) Foreign Application Priority Data
Apr. 13, 2021 (JP) 2021-068049
Oct. 13, 2021 (JP) 2021-168266

(51) Int. Cl. H01M 4/485; H01M 10/0562

(52) U.S. Cl. CPC H01M 4/485; H01M 10/0562; H01M 2004/027

(57) ABSTRACT

A negative-electrode material includes a negative-electrode active material and a solid electrolyte. The negative-electrode active material contains Li, Ti, M1, and O, wherein M1 denotes at least one selected from the group consisting of metal elements and metalloid elements other than Li and Ti. The solid electrolyte contains Li, M2, and X, wherein M2 denotes at least one selected from the group consisting of metal elements and metalloid elements other than Li, and X denotes at least one selected from the group consisting of F, Cl, Br, and I.

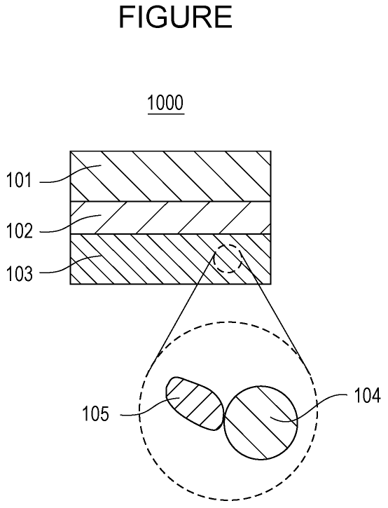

### BACKGROUND

### 1. Technical Field

The present disclosure relates to a negative-electrode material and a battery using the negative-electrode material.

### 2. Description of the Related Art

Lithium titanium oxide has been used as a negative-electrode active material in a lithium-ion battery. Lithium titanium oxide can characteristically improve the cycle characteristics of a battery, has a flat electric potential, and has higher electric potential than metallic lithium. Lithium titanium oxide is therefore a good negative-electrode active material.

Lithium titanium oxide has a problem of slow lithium diffusion in the lithium titanium oxide and difficulty in charging and discharging at a high rate. For example, Lina Hou et al., “Zr-doped Li₄Ti₅O₁₂ anode materials with high specific capacity for lithium-ion batteries”, Journal of Alloys and Compounds 774 (2019) 38-45 discloses the use of Zr-doped Li₄Ti₅O₁₂ as a negative-electrode active material in order to improve rate performance in a liquid battery containing an electrolytic solution.

### SUMMARY

One non-limiting and exemplary embodiment provides a novel negative-electrode material that is suitable for use in a solid-state battery and contains an oxide containing lithium and titanium.

In one general aspect, the techniques disclosed here feature a negative-electrode material according to the present disclosure includes a negative-electrode active material and a solid electrolyte, wherein the negative-electrode active material contains Li, Ti, M1, and O, M1 denotes at least one selected from the group consisting of metal elements and metalloid elements other than Li and Ti, and the solid electrolyte contains Li, M2, and X, M2 denotes at least one selected from the group consisting of metal elements and metalloid elements other than Li, and X denotes at least one selected from the group consisting of F, Cl, Br, and I.

The present disclosure provides a novel negative-electrode material that is suitable for use in a solid-state battery and contains an oxide containing lithium and titanium.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWING

FIGURE is a cross-sectional view of a battery according to a second embodiment.

### DETAILED DESCRIPTIONS

### (Outline of One Aspect of the Present Disclosure)

A negative-electrode material according to a first aspect of the present disclosure includes:
a negative-electrode active material; and
a solid electrolyte,
wherein the negative-electrode active material contains Li, Ti, M1, and O,
M1 denotes at least one selected from the group consisting of metal elements and metalloid elements other than Li and Ti, and
the solid electrolyte contains Li, M2, and X,
M2 denotes at least one selected from the group consisting of metal elements and metalloid elements other than Li, and

X denotes at least one selected from the group consisting of F, Cl, Br, and I.

The negative-electrode active material in the negative-electrode material according to the first aspect further contains, in addition to Li, Ti, and O, at least one element M1 selected from the group consisting of metal elements and metalloid elements other than Li and Ti. When the negative-electrode material is composed of a combination of such a negative-electrode active material and the solid electrolyte containing Li, M2, and X, the negative-electrode material according to the first aspect can improve the charge-discharge rate of the battery. Thus, the first aspect of the present disclosure provides a novel negative-electrode material that is suitable for use in a solid-state battery and contains an oxide containing lithium and titanium.

According to a second aspect of the present disclosure, for example, M1 in the negative-electrode material according to the first aspect may contain at least one selected from the group consisting of Zr, Cs, Ce, and Ca.

A negative-electrode material according to the second aspect can further improve the charge-discharge rate of the battery.

According to a third aspect of the present disclosure, for example, M1 in the negative-electrode material according to the second aspect may contain Zr.

A negative-electrode material according to the third aspect can further improve the charge-discharge rate of the battery.

According to a fourth aspect of the present disclosure, for example, M1 in the negative-electrode material according to the third aspect may be Zr.

A negative-electrode material according to the fourth aspect can further improve the charge-discharge rate of the battery.

According to a fifth aspect of the present disclosure, for example, the negative-electrode active material in the negative-electrode material according to any one of the first to fourth aspects may be represented by the formula (1):

Li₄Ti_{5-α}M1_{α}O₁₂ formula (1)
wherein α satisfies 0<α≤0.3.

A negative-electrode material according to the fifth aspect can further improve the charge-discharge rate of the battery and improve the charge-discharge efficiency of the battery.

According to a sixth aspect of the present disclosure, for example, a in the formula (1) in the negative-electrode material according to the fifth aspect may satisfy 0<α≤0.2.

A negative-electrode material according to the sixth aspect can further improve the charge-discharge rate of the battery.

According to a seventh aspect of the present disclosure, for example, a in the formula (1) in the negative-electrode material according to the sixth aspect may satisfy 0.01≤α≤0.1.

A negative-electrode material according to the seventh aspect can further improve the charge-discharge rate of the battery.

According to an eighth aspect of the present disclosure, for example, the negative-electrode active material in the negative-electrode material according to any one of the first to fourth aspects may be represented by the formula (2):

Li_{4-β}Ti₅M1_{β}O₁₂ formula (2)
wherein β satisfies 0<β≤0.3.

A negative-electrode material according to the eighth aspect can further improve the charge-discharge rate of the battery and improve the charge-discharge efficiency of the battery.

According to a ninth aspect of the present disclosure, for example, β in the formula (2) in the negative-electrode material according to the eighth aspect may satisfy 0 <β≤0.1.

A negative-electrode material according to the ninth aspect can further improve the charge-discharge rate of the battery.

According to a tenth aspect of the present disclosure, for example, β in the formula (2) in the negative-electrode material according to the ninth aspect may satisfy 0.01≤β≤0.06.

A negative-electrode material according to the tenth aspect can further improve the charge-discharge rate of the battery.

According to an eleventh aspect of the present disclosure, for example, M2 in the negative-electrode material according to any one of the first to tenth aspects may contain Y.

A negative-electrode material according to the eleventh aspect can further improve the charge-discharge rate of the battery.

According to a twelfth aspect of the present disclosure, for example, X in the negative-electrode material according to any one of the first to eleventh aspects may be at least one selected from the group consisting of Cl, Br, and I.

A negative-electrode material according to the twelfth aspect can further improve the charge-discharge rate of the battery.

According to a thirteenth aspect of the present disclosure, for example, the solid electrolyte in the negative-electrode material according to any one of the first to twelfth aspects may be substantially free of sulfur.

A negative-electrode material according to the thirteenth aspect has high safety.

A battery according to a fourteenth aspect of the present disclosure includes:
a positive-electrode layer;
a negative-electrode layer; and
an electrolyte layer between the positive-electrode layer and the negative-electrode layer,
wherein the negative-electrode layer contains the negative-electrode material according to any one of the first to thirteenth aspects.

The battery according to the fourteenth aspect has an improved charge-discharge rate.

### Embodiments of the Present Disclosure

Embodiments of the present disclosure are described below with reference to the accompanying drawings. The present disclosure is not limited to these embodiments.

### First Embodiment

A negative-electrode material according to a first embodiment contains a negative-electrode active material and a solid electrolyte. The negative-electrode active material contains Li, Ti, M1, and O. M1 denotes at least one selected from the group consisting of metal elements and metalloid elements other than Li and Ti. The solid electrolyte contains Li, M2, and X. M2 denotes at least one selected from the group consisting of metal elements and metalloid elements other than Li, and X denotes at least one selected from the group consisting of F, Cl, Br, and I.

The negative-electrode active material in the negative-electrode material according to the first embodiment further contains, in addition to Li, Ti, and O, at least one element M1 selected from the group consisting of metal elements and metalloid elements other than Li and Ti. The negative-electrode material composed of a combination of such a negative-electrode active material and the solid electrolyte containing Li, M2, and X can improve the charge-discharge rate of the battery. Thus, the negative-electrode material according to the first embodiment is a novel negative-electrode material that is suitable for use in a solid-state battery and that contains an oxide containing lithium and titanium.

The term “metal elements”, as used herein, refers to
(i) all elements of groups 1 to 12 of the periodic table (except hydrogen) and (ii) all elements of groups 13 to 16 of the periodic table (except B, Si, Ge, As, Sb, Te, C, N, P, S, and Se). Thus, the metal elements are a group of elements that can become a cation when forming an inorganic compound with a halide.

The term “metalloid elements”, as used herein, refers to B, Si, Ge, As, Sb, and Te.

In order to further improve the charge-discharge rate of the battery, in the negative-electrode active material in the negative-electrode material according to the first embodiment, M1 may contain at least one selected from the group consisting of Zr (that is, zirconium), Cs (that is, cesium), Ce (that is, cerium), and Ca (that is, calcium).

Such a structure can further improve the ionic conductivity of the negative-electrode active material. Thus, the negative-electrode material according to the first embodiment can further improve the charge-discharge rate of the battery.

In order to further improve the charge-discharge rate of the battery, M1 in the negative-electrode active material in the negative-electrode material according to the first embodiment may contain Zr. Thus, the negative-electrode active material in the negative-electrode material according to the first embodiment may contain Zr as the metal element M1.

Such a structure can further improve the ionic conductivity of the negative-electrode active material. Thus, the negative-electrode material according to the first embodiment can further improve the charge-discharge rate of the battery.

In order to further improve the charge-discharge rate of the battery and improve the charge-discharge efficiency of the battery, the negative-electrode active material contained in the negative-electrode active material according to the first embodiment may be represented by the formula (1):

Li₄Ti_{5-α}Zr_{α}O₁₂ formula (1)
wherein α satisfies 0<α≤0.3.

In order to further improve the charge-discharge efficiency of the battery, a in the formula (1) may satisfy 0<α≤0.2.

In order to further improve the charge-discharge efficiency of the battery, a in the formula (1) may satisfy 0.01<α≤0.1.

In order to further improve the charge-discharge rate of the battery and improve the charge-discharge efficiency of the battery, the negative-electrode active material contained in the negative-electrode active material according to the first embodiment may be represented by the formula (2):

Li_{4ββ}Ti₅M1_{β}O₁₂ formula (2)
wherein β satisfies 0<β≤0.3.

In order to further improve the charge-discharge efficiency of the battery, β in the formula (2) may satisfy 0<β≤0.1.

In order to further improve the charge-discharge efficiency of the battery, β in the formula (2) may satisfy 0.01≤β≤0.06.

The negative-electrode active material containing Zr may be, for example, a compound represented by the formula Liₐ₁Ti_{b1}Zr_{c1}Me1_{d1}Oₑ₁, wherein a1+4b1+4c1+m1d1=2e1, c1>0, Me1 is at least one selected from the group consisting of metal elements and metalloid elements other than Li and Y, and m1 denotes the valence of Me1. Me1 may be at least one selected from the group consisting of Mg, Ca, Sr, Ba, Zn, Sc, Al, Ga, Bi, Zr, Hf, Ti, Sn, Ta, and Nb.

As described above, the solid electrolyte in the negative-electrode material according to the first embodiment contains Li, M2, and X. The solid electrolyte containing Li, M2, and X in the negative-electrode material according to the first embodiment is hereinafter referred to as a first solid electrolyte.

The first solid electrolyte may consist essentially of Li, M2, and X. The phrase “the first solid electrolyte consists essentially of Li, M2, and X” means that the ratio (that is, mole fraction) of the sum of the amounts of Li, M2, and X to the sum of the amounts of all the elements constituting the solid electrolyte in the first solid electrolyte is 90% or more. For example, the ratio (that is, mole fraction) may be 95% or more. The first solid electrolyte may be composed of only Li, M2, and X.

In order to increase the ionic conductivity to improve the charge-discharge rate of the battery, M2 may contain at least one element selected from the group consisting of group 1 elements, group 2 elements, group 3 elements, group 4 elements, and lanthanoid elements. To increase the ionic conductivity to improve the charge-discharge rate of the battery, M2 may contain at least one element selected from the group consisting of group 5 elements, group 12 elements, group 13 elements, and group 14 elements.

Examples of the group 1 elements include Na, K, Rb, and Cs. Examples of the group 2 elements include Mg, Ca, Sr, and Ba. Examples of the group 3 elements include Sc and Y. Examples of the group 4 elements include Ti, Zr, and Hf. Examples of the lanthanoid elements include La, Ce, Pr, Nd, Sm, Eu, Gd, Tb, Dy, Ho, Er, Tm, Yb, and Lu. Examples of the group 5 elements include Nb and Ta. Examples of the group 12 elements include Zn. Examples of the group 13 elements include Al, Ga, and In. Examples of the group 14 elements include Sn.

In order to increase the ionic conductivity to improve the charge-discharge rate of the battery, M2 may contain at least one element selected from the group consisting of Na, K, Mg, Ca, Sr, Ba, Sc, Y, Zr, Hf, La, Ce, Pr, Nd, Sm, Eu, Gd, Tb, Dy, Ho, Er, Tm, Yb, and Lu.

In order to increase the ionic conductivity to improve the charge-discharge rate of the battery, M2 may contain at least one element selected from the group consisting of Mg, Ca, Sr, Y, Sm, Gd, Dy, and Hf.

In order to further improve the charge-discharge rate of the battery, M2 in the first solid electrolyte may contain Y (that is, yttrium). In other words, in the first embodiment, the first solid electrolyte may contain Y as the metal element M2.

In order to further improve the charge-discharge rate of the battery, X may contain at least one element selected from the group consisting of Cl, Br, and I.

In order to further improve the charge-discharge rate of the battery, X may contain at least two elements selected from the group consisting of Cl, Br, and I.

In order to further improve the charge-discharge rate of the battery, X1 may contain Cl, Br, and I.

The first solid electrolyte may be a material represented by the formula (3):

Li_{α}M2₆₂ X_{γ} formula (3)
wherein α, β, and γ each independently denote a value greater than 0. M2 and X are as described above.

The terms “metalloid elements” and “metal elements”, as used herein, are as defined above. More specifically, the metal elements are a group of elements that can become cations when the inorganic compounds represented by the formulae (1), (2), and (3) are formed.

Such a structure can further improve the ionic conductivity of the first solid electrolyte. This can improve the charge-discharge rate of the battery.

The first solid electrolyte containing Y may be, for example, a compound represented by the formula Liₐ₂Me2_{2b}Y_{c2}X₆, wherein a2+m2b2+3c2=6, c2>0, Me2 denotes at least one selected from the group consisting of metal elements and metalloid elements other than Li and Y, and m2 denotes the valence of Me2. Me2 may be at least one selected from the group consisting of Mg, Ca, Sr, Ba, Zn, Sc, Al, Ga, Bi, Zr, Hf, Ti, Sn, Ta, and Nb.

The first solid electrolyte may be of any shape. The shape of the first solid electrolyte may be, for example, a needle-like shape, a spherical shape, an ellipsoidal shape, or a fibrous shape. For example, the first solid electrolyte may be particulate. The first solid electrolyte may be formed in a pellet or sheet shape.

In order to further increase the ionic conductivity and to form a good dispersion state with another material, such as the negative-electrode active material, for example, when the first solid electrolyte is particulate (for example, spherical), the first solid electrolyte may have a median size of 0.1 μm or more and 100 μm or less. The median size means the particle size at which the cumulative volume in the volumetric particle size distribution is equal to 50%. The volumetric particle size distribution can be measured with a laser diffraction measuring apparatus or an image analyzer.

The median size may be 0.5 μm or more and 10 μm or less. The first solid electrolyte with such a median size has high ionic conductivity.

The first solid electrolyte is, for example, substantially free of sulfur. The phrase “the first solid electrolyte is substantially free of sulfur” means that the first solid electrolyte is free of sulfur as a constituent element except for sulfur inevitably mixed therewith as an impurity. In this case, the amount of sulfur mixed with the first solid electrolyte as an impurity is, for example, 1% by mole or less. The first solid electrolyte may be free of sulfur. The first solid electrolyte free of sulfur does not produce hydrogen sulfide even when exposed to the atmosphere, and therefore has high safety.

The negative-electrode material according to the first embodiment may further contain another solid electrolyte with a composition or a crystal structure different from that of the first solid electrolyte. In such a case, the mass of the first solid electrolyte may be 5% by mass or more and 95% by mass or less of the total mass of solid electrolytes contained in the negative-electrode material. Examples of the solid electrolyte with a composition different from that of the first solid electrolyte include solid sulfide electrolytes, solid oxide electrolytes, solid polymer electrolytes, and complex hydride solid electrolytes. Examples of the solid sulfide electrolytes, the solid oxide electrolytes, the solid polymer electrolytes, and the complex hydride solid electrolytes are the same as examples of solid electrolytes that can be used for a positive-electrode layer 101 according to a second embodiment described later.

### Second Embodiment

A second embodiment of the present disclosure is described below. The matters described in the first embodiment may be omitted.

A battery including a negative-electrode layer containing the negative-electrode material according to the first embodiment is described in the second embodiment.

FIGURE is a cross-sectional view of a battery 1000 according to the second embodiment.

The battery 1000 according to the second embodiment includes a positive-electrode layer 101, an electrolyte layer 102, and a negative-electrode layer 103. The electrolyte layer 102 is located between the positive-electrode layer 101 and the negative-electrode layer 103. The negative-electrode layer 103 contains the negative-electrode material according to the first embodiment.

With such a structure, the battery 1000 according to the second embodiment can have an improved charge-discharge rate.

An example of the battery 1000 according to the present embodiment is an all-solid-state battery. The all-solid-state battery may be a primary battery or a secondary battery.

Components of the battery 1000 according to the present embodiment are described in more detail below.

### (Negative-Electrode Layer)

As described above, in the second embodiment, the negative-electrode layer 103 contains the negative-electrode material according to the first embodiment. The negative-electrode material is as described in the first embodiment.

As illustrated in FIGURE, the negative-electrode layer 103 may contain a negative-electrode active material particle 104 and a first solid electrolyte particle 105.

The negative-electrode active material particle 104 may have a median size of 0.1 μm or more and 100 μm or less. When the negative-electrode active material particle 104 has a median size of 0.1 μm or more, the negative-electrode active material particle 104 and the first solid electrolyte particle 105 in the negative-electrode layer 103 have a good dispersion state. This improves the charge-discharge characteristics of the battery 1000. The negative-electrode active material particle 104 with a median size of 100 μm or less has an improved lithium diffusion rate therein. This allows the battery 1000 to operate at high output power.

The negative-electrode active material particle 104 may have a larger median size than the first solid electrolyte particle 105. This improves the dispersion state of the negative-electrode active material particle 104 and the first solid electrolyte particle 105 in the negative-electrode layer 103.

In the negative-electrode layer 103 according to the present embodiment, the first solid electrolyte particle 105 may be in contact with the negative-electrode active material particle 104, as illustrated in FIGURE.

The negative-electrode layer 103 according to the present embodiment may contain a plurality of the first solid electrolyte particles 105 and a plurality of the negative-electrode active material particles 104.

In the negative-electrode layer 103 according to the present embodiment, the first solid electrolyte particle 105 content may be the same as or different from the negative-electrode active material particle 104 content.

In the negative-electrode layer 103, the volume ratio Vn of the volume of the negative-electrode active material particle to the total volume of the negative-electrode active material particle 104 and the first solid electrolyte particle 105 may be 0.3 or more and 0.95 or less. At a volume ratio Vn of 0.3 or more, the battery 1000 can have an improved energy density. On the other hand, at a volume ratio Vn of 0.95 or less, the battery 1000 can have improved output.

The negative-electrode layer 103 may have a thickness of 10 μm or more and 500 μm or less.

When the negative-electrode layer 103 has a thickness of 10 μm or more, the battery 1000 can have a sufficient energy density. When the negative-electrode layer 103 has a thickness of 500 μm or less, the battery 1000 can have improved output.

### (Positive-Electrode Layer)

The positive-electrode layer 101 contains a material that can adsorb and desorb metal ions (for example, lithium ions). The positive-electrode layer 101 may contain a positive-electrode active material.

Examples of the positive-electrode active material include lithium-containing transition metal oxides, transition metal fluorides, polyanionic materials, fluorinated polyanionic materials, transition metal sulfides, transition metal oxyfluorides, transition metal oxysulfides, and transition metal oxynitrides. Examples of the lithium-containing transition metal oxides include Li(NiCoAl)O₂, Li(NiCoMn)O₂, and LiCoO₂. In particular, the use of a lithium-containing transition metal oxide as the positive-electrode active material can reduce production costs and increase the average discharge voltage.

In order to improve the charge-discharge capacity, the positive-electrode active material may be lithium nickel cobalt manganese oxide.

The positive-electrode layer 101 may contain a solid electrolyte. Such a structure increases lithium-ion conductivity in the positive-electrode layer 101 and enables operation at high output power.

Examples of the solid electrolyte in the positive-electrode layer 101 include solid halide electrolytes, solid sulfide electrolytes, solid oxide electrolytes, solid polymer electrolytes, and complex hydride solid electrolytes.

The solid halide electrolytes may be, for example, the materials exemplified above as the first solid electrolyte.

Examples of the solid sulfide electrolytes include Li₂S—P₂S₅, Li₂S—SiS₂, Li₂S—B₂S₃, Li₂S—GeS₂, Li_{3.25}Ge_{0.2}SP_{0.75}S₄, and Li₁₀GeP₂S₁₂. LiX′, Li₂O, M′Oq, LipM′Oq, or the like may be added to these. X′ denotes at least one selected from the group consisting of F, Cl, Br, and I. M′ denotes at least one selected from the group consisting of P, Si, Ge, B, Al, Ga, In, Fe, and Zn. p and q denote a natural number.

Examples of the solid oxide electrolytes include:
(i) NASICON-type solid electrolytes, such as LiTi₂(PO₄)₃ and element-substituted products thereof,
(ii) perovskite-type solid electrolytes, such as (LaLi)TiO₃,
(iii) LISICON-type solid electrolytes, such as Li₁₄ZnGe₄O₁₆, Li₄SiO₄, LiGeO₄, and element-substituted products thereof,
(iv) garnet-type solid electrolytes, such as Li₇La₃Zr₂O₁₂ and element-substituted products thereof,
(v) Li₃PO₄ and N-substituted products thereof,
(vi) Li₃N and H-substituted products thereof, and
(vii) glasses and glass ceramics based on a Li—B—O compound, such as LiBO₂ or Li₃BO₃, to which Li₂SO₄, Li₂CO₃, or the like is added.

Examples of the solid polymer electrolytes include polymers and lithium salt compounds.

The polymer may have an ethylene oxide structure. A polymer with an ethylene oxide structure can contain a large amount of lithium salt and can further increase the ionic conductivity.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. A lithium salt selected from these may be used alone. Alternatively, a mixture of two or more lithium salts selected from these may be used.

Examples of the complex hydride solid electrolytes include LiBH₄—LiI and LiBH₄—P₂S₅.

Positive-electrode active material particles may have a median size of 0.1 μm or more and 100 μm or less. When the positive-electrode active material particles have a median size of 0.1 μm or more, the positive-electrode active material particles and solid electrolyte particles in the positive-electrode layer 101 have a good dispersion state. This improves the charge-discharge characteristics of the battery 1000. The positive-electrode active material particles with a median size of 100 μm or less have an improved lithium diffusion rate therein. This allows the battery 1000 to operate at high output power.

The positive-electrode active material particles may have a larger median size than the solid electrolyte particles. This enables the positive-electrode active material particles and the solid electrolyte particles to form a good dispersion state.

In the positive-electrode layer 101, the volume ratio Vp of the volume of the positive-electrode active material particles to the total volume of the positive-electrode active material particles and the solid electrolyte particles may be 0.3 or more and 0.95 or less. At a volume ratio Vp of 0.3 or more, the battery 1000 can have an improved energy density. On the other hand, at a volume ratio Vp of 0.95 or less, the battery 1000 can have improved output.

The positive-electrode layer 101 may have a thickness of 10 μm or more and 500 μm or less.

When the positive-electrode layer 101 has a thickness of 10 μm or more, the battery 1000 can have a sufficient energy density. When the positive-electrode layer 101 has a thickness of 500 μm or less, the battery 1000 can have improved output.

The positive-electrode active material may be covered. A material with low electronic conductivity can be used as a covering material. The covering material may be an oxide material, a solid oxide electrolyte, or the like.

Examples of the oxide material include SiO₂, Al₂O₃, TiO₂, B₂O₃, Nb₂O₅, WO₃, and ZrO₂.

Examples of the solid oxide electrolyte include
(i) Li—Nb—O compounds, such as LiNbO₃,
(ii) Li—B—O compounds, such as LiBO₂ and Li₃BO₃,
(iii) Li—Al—O compounds, such as LiAlO₂,
(iv) Li—Si—O compounds, such as Li₄SiO₄,
(v) Li—S—O compounds, such as Li₂SO₄,
(vi) Li—Ti—O compounds, such as Li₄Ti₅O₁₂,
(vii) Li—Zr—O compounds, such as Li₂ZrO₃,
(viii) Li—Mo—O compounds, such as Li₂MoO₃,
(ix) Li—V—O compounds, such as LiV₂O₅, and
(x) Li—W—O compounds, such as Li₂WO₄.

Solid oxide electrolytes have high ionic conductivity and high high-potential stability. Thus, the use of a solid oxide electrolyte can improve the charge-discharge efficiency.

### (Electrolyte Layer)

The electrolyte layer 102 contains a solid electrolyte. The solid electrolyte in the electrolyte layer 102 may be the material described above (for example, a solid halide electrolyte, a solid sulfide electrolyte, a solid oxide electrolyte, a solid polymer electrolyte, a complex hydride solid electrolyte, or the like).

The electrolyte layer 102 may contain two or more of the materials described as the solid electrolyte material. For example, the electrolyte layer 102 may contain a first solid electrolyte and a solid sulfide electrolyte.

The electrolyte layer 102 may have a thickness of 1 μm or more and 300 μm or less.

The electrolyte layer 102 with a thickness of 1 μm or more can reduce the short circuit between the positive-electrode layer 101 and the negative-electrode layer 103. The electrolyte layer 102 with a thickness of 300 μm or less can provide the battery 1000 that can operate at high output power.

In order to improve the adhesion between particles, at least one selected from the group consisting of the positive-electrode layer 101, the electrolyte layer 102, and the negative-electrode layer 103 may contain a binder. The binder is used to improve the binding property of a material constituting the electrode.

Examples of the binder include poly(vinylidene difluoride), polytetrafluoroethylene, polyethylene, polypropylene, aramid resin, polyamide, polyimide, polyamideimide, polyacrylonitrile, poly(acrylic acid), poly(methyl acrylate), poly(ethyl acrylate), poly(hexyl acrylate), poly(methacrylic acid), poly(methyl methacrylate), poly(ethyl methacrylate), poly(hexyl methacrylate), poly(vinyl acetate), polyvinylpyrrolidone, polyether, poly(ether sulfone), hexafluoropolypropylene, styrene-butadiene rubber, and carboxymethylcellulose.

The binder may also be a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene.

Two or more binders may be used.

At least one selected from the group consisting of the positive-electrode layer 101 and the negative-electrode layer 103 may contain a conductive aid to increase electronic conductivity.

Examples of the conductive aid include
(i) graphites, such as natural graphite and artificial graphite,
(ii) carbon blacks, such as acetylene black and Ketjen black,
(iii) electrically conductive fibers, such as carbon fibers and metal fibers,
(iv) fluorocarbons,
(v) metal powders, such as aluminum,
(vi) electrically conductive whiskers, such as zinc oxide and potassium titanate,
(vii) electrically conductive metal oxides, such as titanium oxide, and
(viii) electrically conductive polymers, such as polyaniline, polypyrrole, and polythiophene. To reduce the cost, the conductive aid (i) or (ii) may be used.

Examples of the shape of a battery according to the present embodiment include a coin shape, a cylindrical shape, a square or rectangular shape, a sheet shape, a button shape, a flat shape, and a layered shape.

### EXAMPLES

The present disclosure is described in detail in the following examples and comparative examples.

### Example 1

### (Preparation of First Solid Electrolyte)

In a dry argon atmosphere with a dew point of −60° C. or less, raw material powders LiBr, YBr₃, LiCl, and YCl₃ were weighed at a mole ratio of Li:Y:Br:Cl=3:1:2:4. These were ground and mixed in a mortar. The mixture was then milled in a planetary ball mill (P-7 manufactured by Fritsch GmbH) at 600 rpm for 25 hours. Thus, a Li₃YBr₂Cl₄ powder was prepared as a first solid electrolyte of Example 1.

### (Evaluation of Composition of First Solid Electrolyte)

The composition of the first solid electrolyte of Example 1 was evaluated by inductive coupled plasma (ICP) emission spectroscopy. As a result, the deviation of Li/Y from the composition of the preparation was 3% or less. Thus, it can be said in Example 1 that the composition of the preparation in the planetary ball mill was almost the same as the composition of the first solid electrolyte thus prepared.

### (Preparation of Negative-Electrode Active Material)

Raw material powders Li₂CO₃, TiO₂, and ZrO(NO₃)₂ were mixed at a mole ratio of Li₂CO₃:TiO₂:ZrO(NO₃)₂=29.58:70.28:0.14. The mixed powder was then milled in a planetary ball mill (P-7 manufactured by Fritsch GmbH) at 150 rpm for 1 hour. The mixed powder was then heat-treated at 900° C. for 12 hours. Thus, a powder of a negative-electrode active material Li₄Ti_{4.99}Zr_{0.01}O₁₂ of Example 1 was prepared.

### (Preparation of Negative-Electrode Material)

In a dry argon atmosphere with a dew point of −60° C. or less, the first solid electrolyte Li₃YBr₂Cl₄ of Example 1, a negative-electrode active material Li₄Ti_{4.99}Zr_{0.01}O₁₂, and a conductive aid VGCF (vapor grown carbon fiber) were weighed at a mass ratio of Li₃YBr₂Cl₄:Li₄Ti_{4.99}Zr_{0.01}O₁₂:VGCF=56.6:39:4.4. These were mixed in an agate mortar to prepare a negative-electrode material of Example 1. VGCF is a registered trademark of Showa Denko K.K.

### (Production of Battery)

In an insulating tube with an inner diameter of 9.5 mm, 20 mg of the negative-electrode material of Example 1 and 80 mg of a solid sulfide electrolyte material Li₆PS₅Cl manufactured by MSE were layered in this order. A pressure of 360 MPa was applied to the layered body to prepare a negative-electrode layer formed from the negative-electrode material of Example 1 and an electrolyte layer formed from Li₆PS₅Cl. Metal In (thickness: 200 μm), metal Li (thickness: 300 μm), and metal In (thickness: 200 μm) were then sequentially layered on the electrolyte layer on the side opposite to the side in contact with the negative-electrode layer. A pressure of 80 MPa was applied to the layered body to form a positive-electrode layer.

Thus, a layered body composed of the positive-electrode layer, the electrolyte layer, and the negative-electrode layer was prepared. A current collector made of stainless steel was then attached to the top and bottom of the layered body, that is, to the positive-electrode layer and the negative-electrode layer, and a current collector lead was attached to the current collector. Finally, an insulating ferrule was used to shield the inside of the insulating tube from the outside atmosphere and to seal the inside of the tube. A battery according to Example 1 was thus produced.

### Example 2

### (Preparation of Negative-Electrode Active Material)

Raw material powders Li₂CO₃, TiO₂, and ZrO(NO₃)₂ were mixed at a mole ratio of Li₂CO₃:TiO₂:ZrO(NO₃)₂=27.83:71.34:0.83. The mixed powder was then milled in a planetary ball mill (P-7 manufactured by Fritsch GmbH) at 150 rpm for 1 hour. The mixed powder was then heat-treated at 900° C. for 12 hours. Thus, a powder of a negative-electrode active material Li₄Ti_{4.98}Zr_{0.02}O₁₂ of Example 2 was prepared.

The procedure was the same as in Example 1 except for the preparation of the negative-electrode active material.

### Example 3

### (Preparation of Negative-Electrode Active Material)

Raw material powders Li₂CO₃, TiO₂, and ZrO(NO₃)₂ were mixed at a mole ratio of Li₂CO₃:TiO₂:ZrO(NO₃)₂=27.53:70.01:2.46. The mixed powder was then milled in a planetary ball mill (P-7 manufactured by Fritsch GmbH) at 150 rpm for 1 hour. The mixed powder was then heat-treated at 900° C. for 12 hours. Thus, a powder of a negative-electrode active material Li₄Ti_{4.94}Zr_{0.06}O₁₂ of Example 3 was prepared.

The procedure was the same as in Example 1 except for the preparation of the negative-electrode active material.

### Example 4

### (Preparation of Negative-Electrode Active Material)

Raw material powders Li₂CO₃, TiO₂, and ZrO(NO₃)₂ were mixed at a mole ratio of Li₂CO₃:TiO₂:ZrO(NO₃)₂=27.23:68.71:4.06. The mixed powder was then milled in a planetary ball mill (P-7 manufactured by Fritsch GmbH) at 150 rpm for 1 hour. The mixed powder was then heat-treated at 900° C. for 12 hours. Thus, a powder of a negative-electrode active material Li₄Ti_{4.9}Zr_{0.1}O₁₂ of Example 4 was prepared.

The procedure was the same as in Example 1 except for the preparation of the negative-electrode active material.

### Example 5

### (Preparation of Negative-Electrode Active Material)

Raw material powders Li₂CO₃, TiO₂, and ZrO(NO₃)₂ were mixed at a mole ratio of Li₂CO₃:TiO₂:ZrO(NO₃)₂=26.53:65.56:7.91. The mixed powder was then milled in a planetary ball mill (P-7 manufactured by Fritsch GmbH) at 150 rpm for 1 hour. The mixed powder was then heat-treated at 900° C. for 12 hours. Thus, a powder of a negative-electrode active material Li₄Ti_{4.8}Zr_{0.2}O₁₂ of Example 5 was prepared.

The procedure was the same as in Example 1 except for the preparation of the negative-electrode active material.

### Example 6

### (Preparation of Negative-Electrode Active Material)

Raw material powders Li₂CO₃, TiO₂, and Cs₂(CO₃) were mixed at a mole ratio of Li₂CO₃:TiO₂:Cs₂(CO₃)=28.43:71.43:0.14. The mixed powder was then milled in a planetary ball mill (P-7 manufactured by Fritsch GmbH) at 150 rpm for 1 hour. The mixed powder was then heat-treated at 900° C. for 12 hours. Thus, a powder of a negative-electrode active material Li_{3.98}Ti₅Cs_{0.02}O₁₂ of Example 6 was prepared.

The procedure was the same as in Example 1 except for the preparation of the negative-electrode active material.

### Example 7

### (Preparation of Negative-Electrode Active Material)

Raw material powders Li₂CO₃, TiO₂, and Cs₂(CO₃) were mixed at a mole ratio of Li₂CO₃:TiO₂:Cs₂(CO₃)=27.86:71.43:0.71 and were milled in a planetary ball mill (P-7 manufactured by Fritsch GmbH) at 150 rpm for 1 hour. The mixed powder was then heat-treated at 900° C. for 12 hours. Thus, a powder of Li_{3.9}Ti₅Cs_{0.1}O₁₂ was prepared.

The procedure was the same as in Example 1 except for the preparation of the negative-electrode active material.

### Example 8

### (Preparation of Negative-Electrode Active Material)

Raw material powders Li₂CO₃, TiO₂, and Ce(NO₃)₃·6H₂O were mixed at a mole ratio of Li₂CO₃:TiO₂:Ce(NO₃)₃=28.57:71.29:0.14 and were milled in a planetary ball mill (P-7 manufactured by Fritsch GmbH) at 150 rpm for 1 hour. The mixed powder was then heat-treated at 900° C. for 12 hours. Thus, a powder of Li₄Ti_{4.99}Ce_{0.01}O₁₂ was prepared.

The procedure was the same as in Example 1 except for the preparation of the negative-electrode active material.

### Example 9

### (Preparation of Negative-Electrode Active Material)

Raw material powders Li₂CO₃, TiO₂, and Ce(NO₃)₃·6H₂O were mixed at a mole ratio of Li₂CO₃:TiO₂:Ce(NO₃)₃=28.57:71.14:0.29 and were milled in a planetary ball mill (P-7 manufactured by Fritsch GmbH) at 150 rpm for 1 hour. The mixed powder was then heat-treated at 900° C. for 12 hours. Thus, a powder of Li₄Ti_{4.98}Ce_{0.02}O₁₂ was prepared.

The procedure was the same as in Example 1 except for the preparation of the negative-electrode active material.

### Example 10

### (Preparation of Negative-Electrode Active Material)

Raw material powders Li₂CO₃, TiO₂, and Ce(NO₃)₃·6H₂O were mixed at a mole ratio of Li₂CO₃:TiO₂:Ce(NO₃)₃=28.57:70.57:0.86 and were milled in a planetary ball mill (P-7 manufactured by Fritsch GmbH) at 150 rpm for 1 hour. The mixed powder was then heat-treated at 900° C. for 12 hours. Thus, a powder of Li₄Ti_{4.94}Ce_{0.06}O₁₂ was prepared.

The procedure was the same as in Example 1 except for the preparation of the negative-electrode active material.

### Example 11

### (Preparation of Negative-Electrode Active Material)

Raw material powders Li₂CO₃, TiO₂, and CaO were mixed at a mole ratio of Li₂CO₃:TiO₂:CaO=28.39:71.32:0.29 and were milled in a planetary ball mill (P-7 manufactured by Fritsch GmbH) at 150 rpm for 1 hour. The mixed powder was then heat-treated at 900° C. for 12 hours. Thus, a powder of Li_{3.98}Ti₅Ca_{0.02}O₁₂ was prepared.

The procedure was the same as in Example 1 except for the preparation of the negative-electrode active material.

### Example 12

### (Preparation of Negative-Electrode Active Material)

Raw material powders Li₂CO₃, TiO₂, and CaO were mixed at a mole ratio of Li₂CO₃:TiO₂:CaO=27.66:70.92:1.42 and were milled in a planetary ball mill (P-7 manufactured by Fritsch GmbH) at 150 rpm for 1 hour. The mixed powder was then heat-treated at 900° C. for 12 hours. Thus, a powder of Li_{3.9}Ti₅Ca_{0.1}O₁₂ was prepared.

The procedure was the same as in Example 1 except for the preparation of the negative-electrode active material.

### Comparative Example 1

### (Preparation of Negative-Electrode Active Material)

Raw material powders Li₂CO₃ and TiO₂ were mixed at a mole ratio of Li₂CO₃:TiO₂=27.98:72.02. The mixed powder was then milled in a planetary ball mill (P-7 manufactured by Fritsch GmbH) at 150 rpm for 1 hour. The mixed powder was then heat-treated at 900° C. for 12 hours. Thus, a powder of a negative-electrode active material Li₄Ti₅O₁₂ of Comparative Example 1 was prepared.

The procedure was the same as in Example 1 except for the preparation of the negative-electrode active material.

### Comparative Example 2

### (Preparation of Negative-Electrode Material)

In a dry argon atmosphere with a dew point of −60° C. or less, a solid sulfide electrolyte material Li₆PS₅Cl manufactured by MSE, a negative-electrode active material Li₄Ti₅O₁₂ prepared in the same manner as in Comparative Example 1, and a conductive aid VGCF were weighed at a mass ratio of Li₆PS₅Cl:Li₄Ti₅O₁₂:VGCF=56.6:39:4.4 and were mixed in an agate mortar to prepare a negative-electrode material.

The procedure was the same as in Example 1 except for the negative-electrode active material and the preparation of the negative-electrode active material.

### Comparative Example 3

### (Preparation of Negative-Electrode Material)

In a dry argon atmosphere with a dew point of −60° C. or less, a solid sulfide electrolyte material Li₆PS₅Cl manufactured by MSE, a negative-electrode active material Li₄Ti_{4.98}Zr_{0.02}O₁₂ prepared in the same manner as in Example 2, and a conductive aid VGCF were weighed at a mass ratio of Li₆PS₅Cl:Li₄Ti_{4.98}Zr_{0.02}O₁₂:VGCF=56.6:39:4.4 and were mixed in an agate mortar to prepare a negative-electrode material.

The procedure was the same as in Example 1 except for the negative-electrode active material and the preparation of the negative-electrode active material.

### Comparative Example 4

### (Preparation of Negative-Electrode Material)

In a dry argon atmosphere with a dew point of −60° C. or less, a solid sulfide electrolyte material Li₆PS₅Cl manufactured by MSE, a negative-electrode active material Li₄Ti_{4.9}Zr_{0.1}O₁₂ prepared in the same manner as in Example 4, and a conductive aid VGCF were weighed at a mass ratio of Li₆PS₅Cl:Li₄Ti_{4.9}Zr_{0.1}O₁₂:VGCF=56.6:39:4.4 and were mixed in an agate mortar to prepare a negative-electrode material.

The procedure was the same as in Example 1 except for the negative-electrode active material and the preparation of the negative-electrode active material.

### [Charge-Discharge Test]

The batteries of all the examples and the comparative examples were subjected to a charge-discharge test as described below.

The batteries were placed in a thermostat at 25° C. Constant-current discharging (substantially charging) was performed to an electric potential of 0.38 V with respect to a metal Li—In alloy at a current value of 1387 μA corresponding to 1 C rate. An open state was then maintained for 20 minutes. The electric potential of the positive electrode was recovered after the open state for 20 minutes. Constant-current discharging was then performed to an electric potential of 0.38 V with respect to the metal Li—In alloy at a current value of 69 μA.

The ratio of the capacity at the current value of 1387 μA to the total capacity measured in the constant-current discharging at the current value of 1387 μA and in the subsequent constant-current discharging at the current value of 69 μA (hereinafter referred to as “1C capacity ratio”) was determined from the results. The 1C capacity ratio of each battery was determined using the following formula. The 1C capacity ratio indicates the rate performance of the battery. A battery with poor rate performance has a low 1C capacity ratio, and a battery with good rate performance has a high 1C capacity ratio.

1C capacity ratio (%)=capacity at current value of 1387 μA/(capacity at current value of 1387 μA+capacity at current value of 69 μA)×100

Table 1 shows the results.

TABLE 1

| | | Amount of M1 added | | 1 C |
|---|---|---|---|---|
| | | (Value of α in formula (1) | | capacity |
| | | or value of β in formula | First solid | ratio |
| | Active material | (2)) | electrolyte | (%) |
| Comparative | Li₄Ti₅O₁₂ | 0 | Li₃YBr₂Cl₄ | 83.3 |
| example 1 | | | | |
| Comparative | Li₄Ti₅O₁₂ | 0 | Li₆PS₅Cl | 89.2 |
| example 2 | | | | |
| Example 1 | Li₄Ti_{4.99}Zr_{0.01}O₁₂ | 0.01 | Li₃YBr₂Cl₄ | 94.0 |
| Example 2 | Li₄Ti_{4.98}Zr_{0.02}O₁₂ | 0.02 | Li₃YBr₂Cl₄ | 95.2 |
| Comparative | Li₄Ti_{4.98}Zr_{0.02}O₁₂ | 0.02 | Li₆PS₅Cl | 88.1 |
| example 3 | | | | |
| Example 3 | Li₄Ti_{4.94}Zr_{0.06}O₁₂ | 0.06 | Li₃YBr₂Cl₄ | 92.0 |
| Example 4 | Li₄Ti_{4.9}Zr_{0.1}O₁₂ | 0.1 | Li₃YBr₂Cl₄ | 94.1 |
| Comparative | Li₄Ti_{4.9}Zr_{0.1}O₁₂ | 0.1 | Li₆PS₅Cl | 72.4 |
| example 4 | | | | |
| Example 5 | Li₄Ti_{4.8}Zr_{0.2}O₁₂ | 0.2 | Li₃YBr₂Cl₄ | 88.8 |
| Example 6 | Li_{3.98} Ti₅Cs_{0.02}O₁₂ | 0.02 | Li₃YBr₂Cl₄ | 86.8 |
| Example 7 | Li_{3.9}Ti₅Cs_{0.1}O₁₂ | 0.1 | Li₃YBr₂Cl₄ | 84.8 |
| Example 8 | Li₄Ti_{4.99}Ce_{0.01}O₁₂ | 0.01 | Li₃YBr₂Cl₄ | 89.9 |
| Example 9 | Li₄Ti_{4.98}Ce_{0.02}O₁₂ | 0.02 | Li₃YBr₂Cl₄ | 92.9 |
| Example 10 | Li₄Ti_{4.94}Ce_{0.06}O₁₂ | 0.06 | Li₃YBr₂Cl₄ | 87.5 |
| Example 11 | Li_{3.98}Ti₅Ca_{0.02}O₁₂ | 0.02 | Li₃YBr₂Cl₄ | 84.0 |
| Example 12 | Li_{3.9}Ti₅Ca_{0.1}O₁₂ | 0.1 | Li₃YBr₂Cl₄ | 83.8 |

As shown in Table 1, the batteries according to Examples 1 to 12 including the negative-electrode layer containing the negative-electrode material, which contained the negative-electrode active material containing Li, Ti, M1, and O and the solid electrolyte containing Li, M2, and X, had a higher 1C capacity ratio than the battery according to Comparative Example 1. In Examples 1 to 12, the negative-electrode active material contains Zr, Cs, Ce, or Ca as M1, and the first solid electrolyte contains Y as M2. The reason for a high 1C capacity ratio in the negative-electrode materials of Examples 1 to 12 is probably due to an improved transport rate of lithium ions in the negative-electrode active material.

The results of Examples 1 to 5 show that the 1C capacity ratio was further increased when the component ratio a of M1 (that is, Zr in this case) in the formula (1) was 0.01 or more and 0.1 or less. This is probably due to a further improved transport rate of lithium ions in the negative-electrode active material. On the other hand, even in a system in which M1 (that is, Zr in this case) was present in the negative-electrode active material, the use of Li₆PS₅Cl in the first solid electrolyte decreased the 1C capacity ratio. This is probably because Zr-sulfur bonding at the interface between the negative-electrode active material and the first solid electrolyte forms a layer that hinders lithium-ion transport.

A battery according to the present disclosure can be used as an all-solid-state lithium-ion secondary battery, for example.

What is claimed is:

1. A negative-electrode material comprising:
a negative-electrode active material; and
a solid electrolyte,
wherein the negative-electrode active material contains Li, Ti, M1, and O,
M1 denotes at least one selected from the group consisting of metal elements and metalloid elements other than Li and Ti, and
the solid electrolyte contains Li, M2, and X,
M2 denotes at least one selected from the group consisting of metal elements and metalloid elements other than Li, and
X denotes at least one selected from the group consisting of F, Cl, Br, and I.

2. The negative-electrode material according to claim 1, wherein M1 contains at least one selected from the group consisting of Zr, Cs, Ce, and Ca.

3. The negative-electrode material according to claim 2, wherein M1 contains Zr.

4. The negative-electrode material according to claim 3, wherein M1 denotes Zr.

5. The negative-electrode material according to claim 1, wherein the negative-electrode active material is represented by the formula (1):
Li₄Ti_{5-α}M1_{α}O₁₂ formula (1)
wherein α satisfies 0<α≤0.3.

6. The negative-electrode material according to claim 5, wherein α satisfies 0<α≤0.2 in the formula (1).

7. The negative-electrode material according to claim 6, wherein α satisfies 0.01 ≤α≤0.1 in the formula (1).

8. The negative-electrode material according to claim 1, wherein the negative-electrode active material is represented by the formula (2):
Li_{4-β}Ti₅M1_{β}O₁₂ formula (2)
wherein β satisfies 0<β≤0.3.

9. The negative-electrode material according to claim 8, wherein β satisfies 0<β≤0.1 in the formula (2).

10. The negative-electrode material according to claim 9, wherein β satisfies 0.01≤α≤0.06 in the formula (2).

11. The negative-electrode material according to claim 1, wherein M2 contains Y.

12. The negative-electrode material according to claim 1, wherein X denotes at least one selected from the group consisting of Cl, Br, and I.

13. The negative-electrode material according to claim 1, wherein the solid electrolyte is substantially free of sulfur.

14. A battery comprising:
a positive-electrode layer;
a negative-electrode layer; and
an electrolyte layer between the positive-electrode layer and the negative-electrode layer,
wherein the negative-electrode layer contains the negative-electrode material according to claim 1.
